(19) United States
(12) Patent Application Publication
(10) Pub. No.: US 2025/0338999 A1
(43) Pub. Date: Nov. 6, 2025

(54) ORBITAL SHAKER BOTTLE AND METHODS OF USE

(71) Applicant: Jacob H. Largeman, Athens, GA (US)

(72) Inventor: Jacob H. Largeman, Athens, GA (US)

(21) Appl. No.: 19/093,551

(22) Filed: Mar. 28, 2025

Related U.S. Application Data
(60) Provisional application No. 63/642,138, filed on May 3, 2024.

(51) Int. Cl. A47J 43/27; B65D 23/04; B65D 41/04; B65D 41/16; B65D 41/26; B65D 51/24; B65D 55/16

(52) U.S. Cl. CPC A47J 43/27; B65D 23/04; B65D 41/04; B65D 41/165; B65D 41/265; B65D 51/242; B65D 55/16

(57) ABSTRACT

A beverage mixing container designed to blend protein powders and dietary supplements with liquids, such as water or milk, into a smooth consistency without an internal mixing object. Featuring a main body with a spherical upper portion tapering to a cylindrical lower portion, the container leverages shape-change technology to achieve efficient mixing through rotational movement, utilizing steep internal curves to accelerate liquids. A removable lower endcap allows bottom-loading of ingredients and simplifies cleaning, while an upper endcap with a spout-closure arm ensures secure access. The compact design, enhanced by the high volume-to-size ratio of the spherical form, fits most cup holders. Easy-grip endcaps with shallow grooves and a specially designed carrying attachment, doubling as a stabilization loop, improve usability and portability. This innovative configuration addresses common issues with traditional shakers, offering a practical, hygienic, and distinctive solution for on-the-go nutrition.

### CROSS-REFERENCE TO RELATED APPLICATIONS

To the full extent permitted by law, the present United States Non-provisional Patent Application hereby claims priority to and the full benefit of United States Provisional Application entitled “Orbital Shaker Bottle and Methods of Use,” having assigned Ser. No. 63/642,138, filed on May 3, 2024, incorporated herein by reference in its entirety.

### FIELD OF THE DISCLOSURE

The present disclosure relates to fluid containers and more specifically, to a shaker bottle configured to mix fluids and powders for consumption.

### BACKGROUND

Portable fluid containers have become essential companions for modern, on-the-go lifestyles, offering a versatile solution for carrying water, juice, tea, coffee, sports mixtures, and more. Available in a diverse array of sizes and shapes, these containers cater to individual preferences and specific needs, whether it's a compact bottle for a quick gym session or a larger vessel for all-day hydration. Designed with convenience, durability, and functionality in mind, they often incorporate innovative features such as insulation, leak-proof lids, and ergonomic grips, making them ideal for everything from daily commutes to outdoor adventures. As consumer demand for practicality and sustainability grows, the variety of portable fluid containers continues to evolve and utility to suit every occasion.

Existing protein shake bottles often present challenges for the average consumer, such as difficulty cleaning stubborn clumps that collect at the bottom and foster microbial growth of a single lid container.

A previous approach includes fluid container, such as a stainless steel water bottle with screw top lid crafted from stainless steel. This fluid container includes a wide-mouth opening for easy filling with fluids, ice, and cleaning. One disadvantage is the fluid container elongated single chamber is poor at mixing protein, pre-workout powders with fluids leaving lumps of powder in the fluid/powder drinks.

Another previous approach includes a shaker bottle designed for mixing protein shakes, pre-workout drinks, and smoothies. This fluid container includes a stainless steel mobile wire whisk that ensures smooth, lump-free blends. The bottle features a leak-proof screw-on lid and a flip cap that snaps shut securely, complemented by a loop top for easy carrying or attaching keys. Included as a feature is a wide mouth for adding ingredients and embossed markings for measuring in ounces and milliliters. One disadvantage is the wire whisk often is lost or misplaced and then the shaker bottle is now just a fluid container.

Therefore, it is readily apparent that there is a recognizable unmet need for an orbital shaker bottle and methods of use that may be configured to address at least some aspects of the problems discussed above.

### SUMMARY

Briefly described, in an example embodiment, the present disclosure may overcome the above-mentioned disadvantages and may meet the recognized need for an orbital shaker bottle and methods of use to provide a protein or other powder shaker bottle designed to enhance usability and hygiene through a unique structural configuration. The apparatus comprises an upper endcap with an integrated spout-closure arm for secure sealing and easy access, a finger loop for improved grip and portability, and a main body container featuring a distinctive sphere-to-cylinder shape that optimizes rotational mixing without requiring a separate internal agitator. The bottle further includes a lower endcap detachably coupled to the main body, facilitating thorough cleaning of hard-to-reach areas and enabling bottom-loading of ingredients to initiate mixing with gravitational assistance. A hinge rod connects the upper endcap and spout-closure arm, ensuring reliable operation. This innovative design addresses common issues with conventional shakers, such as cleaning difficulties and complexity, offering a simpler, more effective solution for preparing smooth protein shakes and other beverages with fewer parts.

Accordingly, in one aspect, the present disclosure may include a removable top and bottom lid to prevent the difficulty cleaning of standard one lid container where debris and stubborn clumps collect at the bottom of the container and remain unreachable, and foster microbial growth and unsanitary fluid transport conditions. The disclosure introduces a removable bottom to compliment the removable top, simplifying cleaning by hand or in a dishwasher and allowing top and bottom-loading of the fluid container as well.

Accordingly, in another aspect, the present disclosure may include a unique shape or configuration of the body of the fluid container to leverage gravity for initiating mixing. Unlike traditional shakers, the present disclosure eliminates the need for a separate internal agitator, such as a stainless steel mobile wire whisk, reducing parts to clean and track, thanks to its innovative sphere-to-cylinder design paired with rotational-mixing, which delivers superior blending when the bottle is rotated back and forth generating smooth, lump-free blends. This distinctive mixing method sets it apart from conventional protein or powder shakers.

Accordingly, in another aspect, the present disclosure pertains to a beverage container designed for blending protein powders and dietary supplements with a user-selected liquid, such as water or milk, utilizing an innovative large spherical shape that transitions into a narrower cylindrical form. By rapidly rotating the apparatus back and forth, it achieves a smooth mix without the need for an internal mixing component, simplifying its design. This distinctive configuration not only ensures efficient mixing but also allows the container to remain compact compared to similar products, maintaining ample volume while offering a visually striking appearance that differentiates it from competitors. Additionally, the invention features a removable bottom, introducing a novel bottom-loading method for adding powders and supplements, which, along with enhancing ease of cleaning, sets it apart from conventional designs.

In an exemplary embodiment of a beverage mixing container to mix a powder and a liquid in a user's hand and fingers via rotation movement including a main body having a spherical center section transitions on one end to an elongated cylindrical lower section having a lower opening and on another end a stubbed cylindrical upper section having a upper opening, the spherical center section and the elongated cylindrical lower section configured to mix the powder and the liquid into a smooth beverage through rotational movement, an upper endcap removably coupled to the upper opening, the upper endcap including a spout and a spout-closure arm pivotally attached to the upper endcap via a hinge rod for sealing and accessing the main body, a lower endcap removably coupled to the lower opening, the lower endcap detachable to enable bottom-loading of the powder and the liquid and to facilitate cleaning, and a finger loop pivotally attached to the upper endcap via the hinge rod, the finger loop configured to receive the finger for stabilization during mixing and to secure the container to an external article.

In an exemplary embodiment of a method of using a beverage mixing container, the method providing a beverage mixing container including a main body having a spherical center section transitioning to an elongated cylindrical lower section with a threaded lower opening and a stubbed cylindrical upper section with a threaded upper opening, an upper endcap removably coupled to the threaded upper opening, the upper endcap including a spout and a spout-closure arm pivotally attached via a hinge rod, a lower endcap removably coupled to the threaded lower opening, a finger loop pivotally attached to the upper endcap via the hinge rod, removing the lower endcap from the main body, loading a powder and a liquid into the main body through the threaded lower opening, reattaching the lower endcap to the threaded lower opening, and rotating the main body back and forth to mix the powder and the liquid into a smooth beverage without an internal mixing object.

In an exemplary embodiment of a beverage mixing container to mix a powder and a liquid in a user's hand and fingers via rotation movement including a main body having a spherical center section tapering to an elongated cylindrical lower section with a threaded lower opening and a stubbed cylindrical upper section with a threaded upper opening, the main body configured to blend the powder and the liquid into a smooth beverage through the rotational movement, the spherical center section providing a compact design with a high volume-to-size ratio, an upper endcap detachably coupled to the threaded upper opening, the upper endcap including a spout, a spout-closure arm pivotally attached via a hinge rod, and a plurality of staggered indentations for gripping, a lower endcap detachably coupled to the threaded lower opening, the lower endcap removable to enable bottom-loading of the powder and the liquid, to facilitate cleaning, and a plurality of staggered indentations for gripping, and a finger loop pivotally attached to the upper endcap via the hinge rod, the finger loop including a flexible loop portion for finger stabilization during mixing and for securing the container to an external article, and a groove at a base of the loop portion to reduce sway when secured.

It is an object of the disclosure herein to provide a carrying loop for easy attachment to a carabiner or strap, doubling as a secure grip during mixing or drinking, particularly benefiting users with smaller hands.

It is an object of the disclosure herein to provide a shape, contour, or innovative large spherical shape that transitions into a narrower cylindrical form on opposing ends. More specifically, characterized by the container's body transitioning from a near-spherical shape to a slimmer cylindrical form at the base. Leveraging the high volume-to-size ratio of spheres (shorter in height), this design enables the bottle to be shorter and more compact than comparable products while retaining a similar capacity. Additionally, this shape or contour produces steep internal curves that function as ramps, enhancing liquid acceleration during rotational. This mechanism enables the container to effectively blend beverages without relying on an internal mixing-assist object, eliminating a separate component that demands extra cleaning and is prone to being misplaced.

It is an object of the disclosure herein to provide a cup holder compatibility, an additional benefit stemming from the shape or contour of the present disclosure. Unlike many protein or powder shakers that are too bulky to fit into standard vehicle cup holders, this invention's compact design, which tapers from a wider spherical top to a narrower cylindrical base, ensures compatibility with nearly all vehicle cup holders. The smaller diameter of the narrower cylindrical base enables insertion in smaller cup holders while the spherical section provides a secure fit by engaging the walls of even the most spacious cup holders, enhancing practicality and convenience for users on the go.

A feature of the present disclosure includes its removable bottom or lid, addressing a common issue with many protein shakers on the market that are tall and have hard-to-reach interiors. Residual powder at the bottom of these containers often clumps and hardens when not cleaned properly, making maintenance challenging. The disclosure overcomes this with a detachable lower endcap or lid, simplifying cleaning and enabling users to load protein powders, supplements, and their preferred mixing liquid from the bottom-a method recommended to optimize the product's mixing performance for a smooth beverage.

A feature of the present disclosure includes its easy-grip endcaps, where both the upper and lower endcaps are designed with wide, shallow grooves to provide a firm grip for users when tightening or unscrewing them. These grooves also contribute to a balanced, symmetrical or symmetry aesthetic, enhancing both functionality and visual appeal.

A feature of the present disclosure includes its carrying attachment, which serves dual purposes beyond the conventional role of securing the bottle to various items using a carabiner, clasp, or strap. This attachment doubles as a stabilization point, allowing users to slip a finger through the loop for added control during use, a benefit particularly valuable for those with smaller hands to maintain a firm and confident grip while mixing vigorously. Additionally, the attachment includes a small groove at its base, minimizing excessive swaying when the bottle is fastened to an object, enhancing both practicality and stability.

A feature of the present disclosure includes with its sphere-to-cylinder design and rotational-mixing method, which delivers smoothly blended beverages without requiring or free of an internal mixing object, simplifying the mixing process.

A feature of the present disclosure includes a carrying attachment, which enables secure attachment to various items via a carabiner, clasp, or strap, with a groove to reduce sway, enhancing portability and stability when secured.

A feature of the present disclosure includes a simplified design eliminating the need for a separate internal agitator; the bottle reduces the number of parts to clean and track, minimizing complexity and the risk of losing components.

A feature of the present disclosure includes a distinctive appearance having a unique sphere-to-cylinder shape not only improves functionality but also gives the bottle a standout look, distinguishing it from other protein shakers on the market.

These and other features of an orbital shaker bottle and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure for an orbital shaker bottle and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1 is a perspective front view of an exemplary embodiment of an orbital shaker bottle according to select embodiments of the disclosure;

FIG. 2 is an exploded view of an exemplary embodiment of an orbital shaker bottle according to select embodiments of the disclosure;

FIG. 3 is a cross-sectional side view of an exemplary embodiment of an orbital shaker bottle showing internal rotational mixing according to select embodiments of the disclosure;

FIG. 4 is a perspective front view of an exemplary embodiment of an orbital shaker bottle shown gripped according to select embodiments of the disclosure; and

FIG. 5 is a series of side views of an exemplary embodiment of an orbital shaker bottle showing a rotational mixing sequence according to select embodiments of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures, specific terminology is employed for clarity. The present disclosure, however, is not intended to be limited to the specific terminology selected; it is to be understood that each specific element includes all technical equivalents that operate in a similar manner to accomplish similar functions. Embodiments of the claims may, however, be embodied in many different forms and should not be construed as limited to the embodiments set forth herein. The examples set forth herein are non-limiting examples and are merely examples among other possible examples. It is recognized herein that the optimum dimensional relationships, to include variations in size, materials, shape, form, position, connection, function and manner of operation, assembly, and use, are intended to be encompassed by the present disclosure.

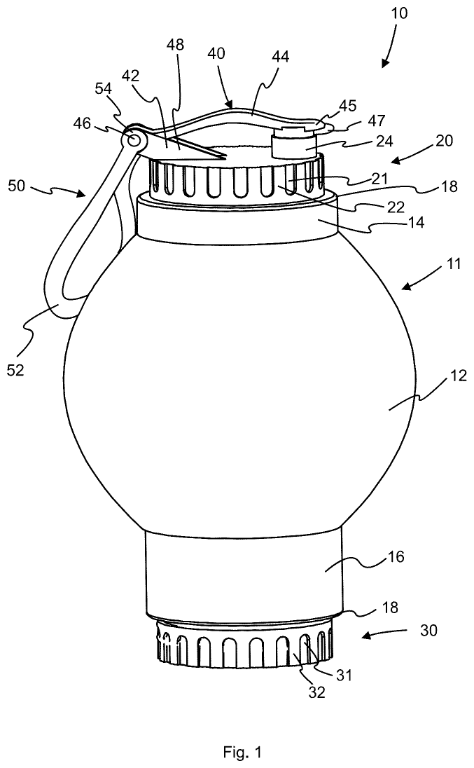

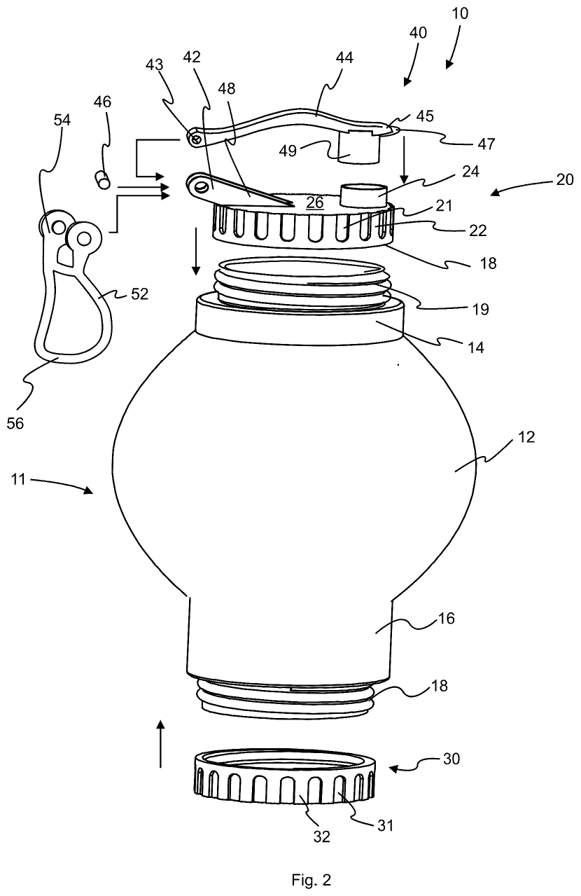

Referring now to FIGS. 1 and 2, by way of example, and not limitation, there is illustrated an example embodiment of a fluid container such as, beverage mixing container 10. Beverage mixing container 10 may include main body 11 with a hollow interior being the liquid-containing area to hold a fluid therein. Main body 11 may be formed or configured in three sections, such as preferably spherical center section 12, on one end extending therefrom lower end of spherical center section 12 may be elongated cylindrical lower section 16 having threaded lower opening 18, and another end extending therefrom upper end of spherical center section 12 may be stubbed cylindrical upper end 14 having threaded upper opening 19.

It is contemplated herein that preferably spherical center section 12, elongated cylindrical lower section 16, and stubbed cylindrical upper end 14 may be configured in other shapes and contours, such as square, rectangle, arc, contour, and the like provided a transition of fluid back and forth between center section 12 and lower section 16 creates a mixing agitation.

It is further contemplated herein that elongated cylindrical lower section 16 may be configured for cup holder compatibility due to elongated cylindrical lower section 16 design tapers at the bottom, enabling elongated cylindrical lower section 16 to fit into almost every vehicle cup holder. Moreover, beverage mixing container 10 may be approximately seven (7) inches at its tallest (with both endcaps screwed down) and four (4) inches at its widest, with elongated cylindrical lower section 16 having two and thirteen-sixteenths

$$( 2 \frac{13}{16} )$$

inches wide. Because of beverage mixing container 10 dimensions, the bottom of elongated cylindrical lower section 16 may be sized thin enough to fit securely in smaller cup holders, and spherical center section 12, of main body 11 may be sized wide enough to make the bottle fit securely or engage in larger cup holders.

Endcaps may be utilized to seal beverage mixing container 10. For example, lower cap 30 may be circular in configuration and have interior threads to match and rotationally secure to or interaction with and seal to thread lower opening 18 of elongated cylindrical lower section 16 to removably seal fluid FL therein beverage mixing container 10. Lower cap 30 preferably provides access to lower section of beverage mixing container 10, specifically spherical center section 12 and elongated cylindrical lower section 16 to enable access to these area for ease of cleaning the interior of beverage mixing container 10. Likewise, upper endcap 20 may be circular in configuration and have interior threads to match and rotationally secure to or interaction with and seal to thread upper opening 19 of stubbed cylindrical upper section 14 to removably seal fluid FL therein beverage mixing container 10. This sealed space serves as the primary liquid-containing compartment.

When lower cap 30 and upper endcap 20 are detached or remove(ing), beverage mixing container 10 components—main body 11 and both lower cap 30 and upper endcap 20—can be cleaned either by placing them in a dishwasher or by manually scrubbing the interior with a small scrubber, ensuring thorough maintenance. This design prevents the formation of hardened protein clumps at the base by allowing complete removal of residue, avoiding accumulation. Additionally, this feature enables bottom-loading of supplements and liquids, positioning the contents to settle against upper endcap 20. Bottom-loading is the recommended method of use, as it leverages gravity to initiate the mixing process, enhancing blending efficiency when the container is rotated R, as further detailed.

It is contemplated herein that lower cap 30 may include a small container for protein powders or supplements storage, a blending attachment to an interior of lower cap 30 for even easier (shake-less) mixing, or simply an endcap with increased weight (0.5 lb, 1 lb, 2 lb, 3 lb, etc.) to add to muscle/strength development while mixing.

Both endcaps, lower cap 30 and upper endcap 20 seal elongated cylindrical lower section 16 and stubbed cylindrical upper section 14 by reattaching lower cap 30 and upper endcap 20 to seal beverage mixing container 10 and hold fluid FL therein, and at least one removal thereof lower cap 30 and upper endcap 20 provides enhanced loading capability and cleanability of beverage mixing container 10.

Unique to this container design is preferably that lower cap 30 additionally provides bottom-loading capability and enhanced cleanability.

Both lower cap 30 and upper endcap 20 may include a contoured outer surface, such as plurality of staggered indentations 31/21 (broad, shallow grooves), mirrored symmetrically respectively, to improve grip, enhancing user handling and control, and enable a solid grip when unscrewing and tightening for ease of removal and attachment of lower cap 30 and upper endcap 20.

Both lower cap 30 and upper endcap 20 may include a tacky outer surface, such as grip surface 32/22, respectively, to improve grip, enhancing user handling and control, and enable ease of removal of lower cap 30 and upper endcap 20.

Moreover, either end cap, or more specifically upper endcap 20 may include an aperture, tube or lip projecting from a container, such as spout 24 preferably affixed to upper surface 26 of upper endcap 20 and to enable user U to drink fluid FL therefrom beverage mixing container 10.

Furthermore, either end cap, or more specifically upper endcap 20 may include a pivot anchor, such as hinge base 42 preferably affixed to upper surface of upper endcap 20.

Furthermore, hinge base 42 may include spout-closure arm 44 configured for pivotable movement about hinge base 42 and pivotally affixed to hinge base 42 by hinge rod 46 passing through cylindrical through-hole 43 on one end securing spout-closure arm 44 to upper endcap 20 and allowing rotation about the hinge for accessing upper endcap 20 and main body 11. Spout-closure arm 44 may pivot from an open position enabling a drink therefrom to a closed position (snap-to-close friction fit feature with tight tolerance seals cap 49 over spout 24 and prevents leaking) to seal spout 24. Spout-closure arm 44 may include protruding lip 47 extending beyond spout-closure arm 44 front edge to enable leverage and facilitate easy prying for opening and closing of spout-closure arm 44 from spout 24 and closure of spout-closure arm 44 onto spout 24.

Main body 11, spherical center section 12, elongated cylindrical lower section 16, stubbed cylindrical upper section 14, upper endcap 20, lower cap 30, hinge base 42, spout-closure arm 44, and the like are preferably constructed of the group consisting of plastic, aluminum, stainless steel, composite, and combinations thereof, which offers a variety of materials, sizes, forms, and shapes; however, other suitable materials such as steel, composites, or the like, can be utilized, provided such material has sufficient strength and/or durability as would meet the purpose described herein.

It is contemplated herein that snap-to-close feature may include a small protrusion at the top of onto spout 24 and a corresponding recess on spout-closure arm 44. Spout-closure arm 44 may be made of a sufficiently malleable material so that it can deform enough to snap fit into spout 24 and maintain a leak-proof seal.

It is contemplated herein that extending ridges 48 of hinge base 42 may be slightly bowed outwards, with their inner faces being parallel to the outer faces of spout-closure arm 44's hinge interface. This shape enables, when spout-closure arm 44 is rotated beyond ninety (90) degrees relative to upper endcap 20, the increasing friction of the hinge (hinge base 42 and hinge rod 46) increases and holds spout-closure arm 44 out of the way of or away from the user's face when drinking from spout 24.

Furthermore, hinge base 42 may include finger loop 50 having loop 52 and pivot bracket 54 having two cylindrical through-holes on the panels extending from the main loop, which hinge rod 46 passes through, connecting finger loop 50 to upper endcap 20 and configured for pivotable movement about hinge base 42 and pivotally affixed to hinge base 42 by hinge rod 46. Finger loop 50 may be utilized as a carrying attachment, which serves dual purposes beyond the conventional role of securing the bottle to various items using a carabiner, clasp, or strap for example. Finger loop 50 doubles as a stabilization point, allowing user U to slip a finger F through the loop (receive(ing), insert(ing) a finger F in the loop 50) for added control/stabilizing during use, a benefit particularly valuable for those with smaller hands to maintain a firm and confident grip while mixing vigorously. Loop 52 may be made of a soft and flexible material, or may include a rigid, inner metal structure or sleeve (not shown) that spans the two loop hinge panels 54 extending from the main loop of loop 52.

It is contemplated herein that loop 52 may be circular, oval, elongated, and other like configurations capable of enabling insertion therein of one or more fingers to enable stabilization, anchor point, and firm grip that allows user U to maintain a confident grip on beverage mixing container 10.

It is contemplated herein that use of finger loop 50 and hinge base 42 may enable rotational pivot thereabout via other designs, such as pivot bracket 54 having three cylindrical through-holes on the panels extending from the main loop, which hinge rod 46 passes through, connecting finger loop 50 to upper endcap 20 and configured for pivotable movement about hinge base 42 and pivotally affixed to hinge base 42 by hinge rod 46 wherein additional of center loop 54 to ensure finger loop 50 stays connected to hinge base 42 while in use.

It is contemplated herein that the use of finger loop 50, when using a carabiner or strap to secure the product to some other external article, there is a small groove 56 at the bottom or base of loop 52 that prevents some unwanted motion, excessive swaying when beverage mixing container 10 is fastened to an object, enhancing both practicality and stability of carabiner or strap along the curve of loop 52.

Finger loop 50 may be made of a flexible material such as liquid silicone rubber, making it comfortable for User U to slide their finger into and out of during operation or transport. For individuals with smaller hands this part serves as an important stabilization, anchor point, and firm grip that allows user U to maintain a confident grip on beverage mixing container 10.

It is intended herein that both finger loop 50 and spout-closure arm 44 may be attached to hinge base 42 and hinge rod 46, and pivot or swing on opposite sides thereof for an efficient design.

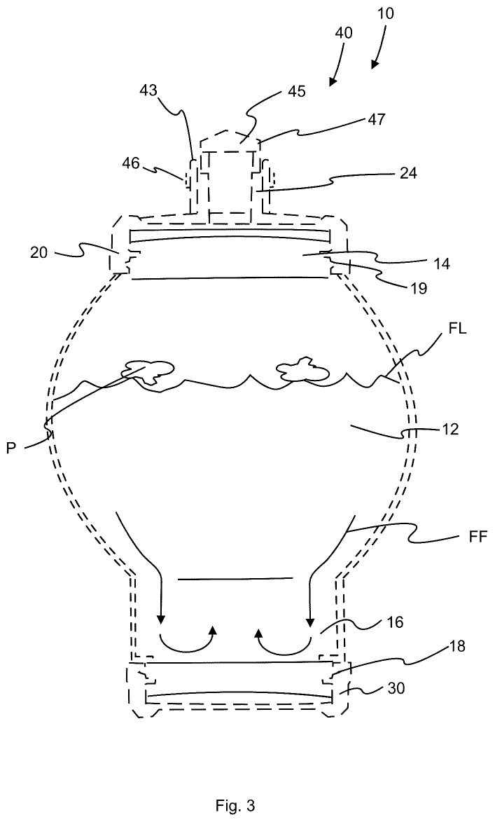

Referring now to FIG. 3, by way of example, and not limitation, there is illustrated a cross-section of beverage mixing container 10. FIG. 3 shows fluid FL and powder P mixing similar to arrows of fluid flow FF traversing transition or shape change between spherical center section 12 and elongated cylindrical lower section 16 (mix sections) created when beverage mixing container 10 is rotated R back and forth. During the intended rotational-mixing process, the internal ramps formed by the shape-change design, as illustrated in FIG. 3 and represented by arrows of fluid flow FF, accelerate fluid FL over spherical center section 12 and tapering elongated cylindrical lower section 16 toward lower cap 30 as beverage mixing container 10 is rotated back and forth creating a turbulence for mixing fluid FL and powder P. The rotational movement leverages internal ramps, combined with abrupt stops between rotations, generates significant torque, which is transferred to fluid FL upon reaching lower cap 30. This energy creates a highly turbulent environment within beverage mixing container 10, enabling the effective blending of smooth beverages without requiring an internal mixing-assist object, thereby simplifying the design and enhancing mixing efficiency.

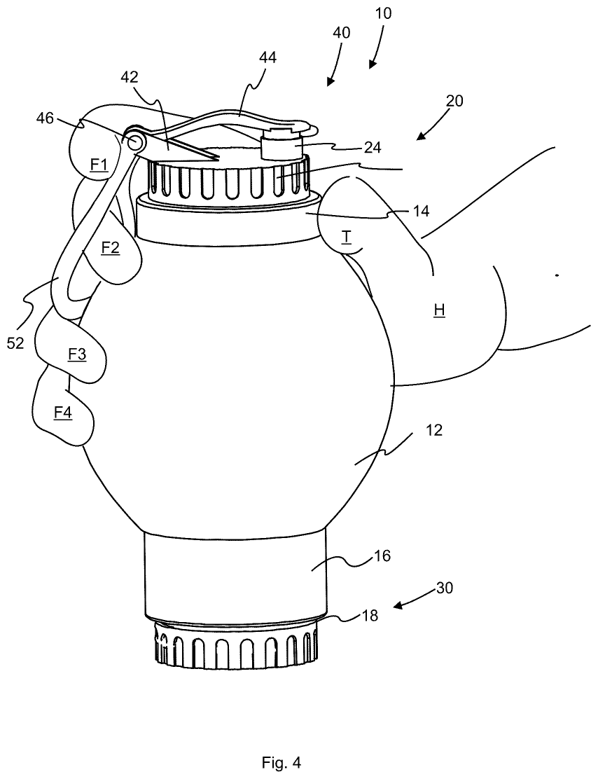

Referring now to FIG. 4, by way of example, and not limitation, there is illustrated a user U gripping beverage mixing container 10. FIG. 4 shows user's U hand H, fingers F, thumb T surrounding beverage mixing container 10, more specifically beverage mixing container 10 may be firmly grasped with one hand, with finger two F2 slipped through finger loop 50 for additional support, if necessary, and rotated back and forth vigorously. Finger loop 50 serves as a way to secure beverage mixing container 10 in user's U hand H during mixing or drinking, which is especially helpful to users U with smaller hands H.

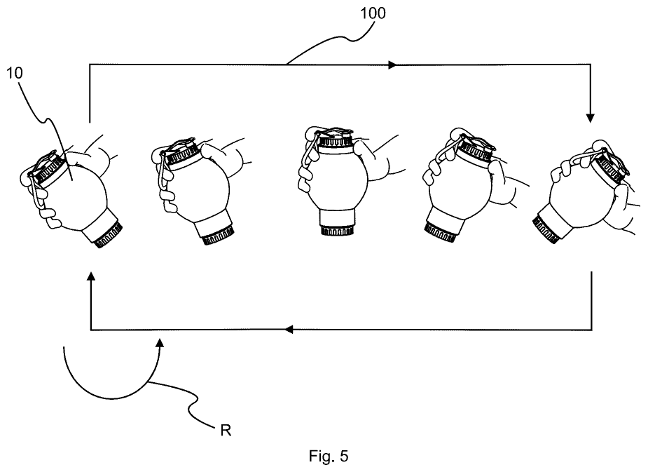

Referring now to FIG. 5, by way of example, and not limitation, there is illustrated a series of five snapshots of beverage mixing container 10 being rotated R back and forth via vigorous rotational mixing process 100. Rotational mixing process 100 shows a series of images illustrating the intended use of the product for mixing a protein shake or other desired beverage, with five sequentially ordered images guided by black arrows. This method, termed Rotational-Mixing, involves user U firmly grasping beverage mixing container 10 and rotating R it back and forth until the beverage achieves a smooth consistency. The sequence demonstrates the ergonomic handling and dynamic motion required to effectively blend the contents, leveraging the container's design to ensure thorough mixing without additional components.

Concerning the description herein, it is to be realized that the optimum dimensional relationships, including variations in size, materials, shape, form, configuration, position, connection, function and manner of operation, assembly, and use, are intended to be encompassed by the present disclosure.

It is further understood herein that the parts and elements of this disclosure may be located or positioned elsewhere based on one of ordinary skill in the art without deviating from the present disclosure.

With respect to the above description, it is to be realized that the optimum dimensional relationships, including variations in size, materials, shape, form, position, movement mechanisms, function and manner of operation, assembly and use, are intended to be encompassed by the present disclosure.

The foregoing description and drawings comprise illustrative embodiments. Regarding the described exemplary embodiments, it should be noted by those skilled in the art that the disclosures within are exemplary only and that various other alternatives, adaptations, and modifications may be made within the scope of the present disclosure. Merely listing or numbering the steps of a method in a particular order does not constitute any limitation on the order of the steps of that method. Many modifications and other embodiments will come to mind for one skilled in the art to which this disclosure pertains, having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions, and alterations can be made thereto without departing from the spirit and scope of the disclosure as defined by the appended claims. Accordingly, the present disclosure is not limited to the specific embodiments illustrated herein but is limited only by the following claims.

1. A beverage mixing container to mix a powder and a liquid in a user's hand and fingers via rotation movement comprising:
a main body having a spherical center section transitions on one end to an elongated cylindrical lower section having a lower opening and on another end a stubbed cylindrical upper section having a upper opening, the spherical center section and the elongated cylindrical lower section configured to mix the powder and the liquid into a smooth beverage through rotational movement;
an upper endcap removably coupled to said upper opening, said upper endcap including a spout and a spout-closure arm pivotally attached to said upper endcap via a hinge rod for sealing and accessing said main body;
a lower endcap removably coupled to said lower opening, said lower endcap detachable to enable bottom-loading of the powder and the liquid and to facilitate cleaning; and
a finger loop pivotally attached to said upper endcap via said hinge rod, said finger loop configured to receive the finger for stabilization during mixing and to secure the container to an external article.

2. The beverage mixing container of claim 1, wherein said transition between said spherical center section and elongated said cylindrical lower section mixes the without an internal mixing object.

3. The beverage mixing container of claim 1, wherein said upper endcap removably coupled to said upper opening and said lower endcap removably coupled to said lower opening via threaded interaction.

4. The beverage mixing container of claim 1, wherein said spherical center section includes internal ramps formed by said transition to said elongated cylindrical lower section, said internal ramps configured to accelerate said liquid toward said lower endcap during rotational movement.

5. The beverage mixing container of claim 1, wherein said elongated cylindrical lower section is sized to fit within a vehicle cup holder, and said spherical center section has a diameter configured to engage walls of said cup holder for a secure fit.

6. The beverage mixing container of claim 1, wherein said upper endcap and said lower endcap each include a plurality of staggered indentations on an outer surface, configured to enhance a user's grip during attachment and removal.

7. The beverage mixing container of claim 1, wherein said finger loop includes a groove at a base thereof, said groove configured to reduce swaying when the container is secured to an external article via a carabiner.

8. The beverage mixing container of claim 1, wherein said spout-closure arm includes a snap-to-close feature with a protrusion on said spout and a corresponding recess on said spout-closure arm, configured to form a leak-proof seal when closed.

9. The beverage mixing container of claim 1, wherein said spout-closure arm includes a protruding lip extending beyond a front edge thereof, said protruding lip configured to facilitate opening and closing of said spout-closure arm.

10. The beverage mixing container of claim 1, wherein said main body is configured to be shorter in height than a cylindrical container of equivalent volume due to a high volume-to-size ratio of said spherical center section.

11. The beverage mixing container of claim 1, wherein said finger loop is formed of a flexible material including liquid silicone rubber, and includes a rigid inner structure to secure said finger loop to said hinge rod.

12. The beverage mixing container of claim 1, wherein said main body, said upper endcap, and said lower endcap are constructed of a material selected from a group consisting of plastic, aluminum, stainless steel, composites, and combinations thereof.

13. A method of using a beverage mixing container, the method comprising:
providing a beverage mixing container having:
a main body having a spherical center section transitioning to an elongated cylindrical lower section with a threaded lower opening and a stubbed cylindrical upper section with a threaded upper opening;
an upper endcap removably coupled to said threaded upper opening, said upper endcap including a spout and a spout-closure arm pivotally attached via a hinge rod;
a lower endcap removably coupled to said threaded lower opening;
a finger loop pivotally attached to said upper endcap via said hinge rod;
removing said lower endcap from said main body;
loading a powder and a liquid into said main body through said threaded lower opening;
reattaching said lower endcap to said threaded lower opening; and
rotating said main body back and forth to mix said powder and said liquid into a smooth beverage without an internal mixing object.

14. The method of claim 13, further comprising stabilizing said container by inserting a finger through said finger loop during rotation.

15. The method of claim 13, wherein rotating said main body back and forth generates a torque through internal ramps formed by said transition between said spherical center section and said elongated cylindrical lower section, said torque creating turbulence to blend said powder and said liquid.

16. The method of claim 13, further comprising securing the container to an external article via said finger loop using a carabiner, wherein a groove at a base of said finger loop reduces swaying of said container.

17. The method of claim 13, further comprising placing the container into a vehicle cup holder, wherein said elongated cylindrical lower section fits within said cup holder and said spherical center section engages walls of said cup holder for stability.

18. The method of claim 13, further comprising cleaning an interior of said main body by removing said lower endcap and manually scrubbing with a scrubber.

19. The method of claim 13, further comprising cleaning an interior of said main body by removing said lower endcap and by placing said main body, said upper endcap, and said lower endcap in a dishwasher.

20. A beverage mixing container to mix a powder and a liquid in a user's hand and fingers via rotation movement comprising:
a main body having a spherical center section tapering to an elongated cylindrical lower section with a threaded lower opening and a stubbed cylindrical upper section with a threaded upper opening, said main body configured to blend the powder and the liquid into a smooth beverage through the rotational movement, said spherical center section providing a compact design with a high volume-to-size ratio;
an upper endcap detachably coupled to said threaded upper opening, said upper endcap including a spout, a spout-closure arm pivotally attached via a hinge rod, and a plurality of staggered indentations for gripping;
a lower endcap detachably coupled to said threaded lower opening, said lower endcap removable to enable bottom-loading of the powder and the liquid, to facilitate cleaning, and a plurality of staggered indentations for gripping; and
a finger loop pivotally attached to said upper endcap via said hinge rod, said finger loop including a flexible loop portion for finger stabilization during mixing and for securing said container to an external article, and a groove at a base of said loop portion to reduce sway when secured.

21. The beverage mixing container of claim 20, wherein said main body is free of an internal mixing object, and the rotational movement leverages an internal ramp formed by said spherical center section and said elongated cylindrical lower section to mix the powder and the liquid.

22. The beverage mixing container of claim 20, wherein said spout-closure arm is configured to pivot beyond ninety degrees relative to said upper endcap, increasing friction in said hinge rod to hold said spout-closure arm away from a user's face during drinking.

23. The beverage mixing container of claim 20, wherein said staggered indentations on said upper endcap are symmetrically mirrored by staggered indentations on said lower endcap, enhancing grip and aesthetic symmetry.

24. The beverage mixing container of claim 20, wherein said finger loop is configured to support users with smaller hands by providing a stabilization point during vigorous rotational mixing.
